(19) United States
(12) Patent Application Publication
(10) Pub. No.: US 2026/0131998 A1
(43) Pub. Date: May 14, 2026

(54) ELEVATOR FILL RATE DETERMINATION

(71) Applicant: KONE Corporation, Helsinki (FI)

(72) Inventor: Zuhair ul HAQ, Helsinki (FI)

(73) Assignee: KONE Corporation, Helsinki (FI)

(21) Appl. No.: 19/443,267

(22) Filed: Jan. 8, 2026

Related U.S. Application Data
(63) Continuation of application No. PCT/EP2023/071960, filed on Aug. 8, 2023.

(51) Int. Cl. B66B 1/34; G06V 10/82; G06V 20/52; G06V 40/10

(52) U.S. Cl. CPC B66B 1/3476; G06V 10/82; G06V 20/53; G06V 40/10; B66B 2201/215

(57) ABSTRACT

According to an aspect, there is provided a device for determining a fill rate of an elevator car. The device may obtain a first set of sensor data associated with an empty elevator car from at least one time-of-flight sensor arranged in the elevator car, the first set of sensor data comprising first data points; remove data points associated with walls of the elevator car from the first data points to obtain floor data points; determine a bounding volume surrounding the floor data points; obtain a second set of sensor data associated with the elevator car from the least one time-of-flight sensor, the second set of sensor data comprising second data points; and calculate the fill rate of the elevator car at least partly based on the second data points inside the bounding volume.

### TECHNICAL FIELD

Various examples generally relate to the field of elevator systems. In particular, some examples relate to a solution for determining the fill rate of an elevator car based on sensor data.

### BACKGROUND

Modern elevator systems feature multiple sensors, for example, cameras or other sensor types, for various tasks, such as for detecting any blocks between closing doors. It may also be possible to calculate a fill rate of an elevator based on sensor data. When the fill rate is known, the flow of people may be optimized, unnecessary stops on floors may be avoided, and the overall user experience may be improved.

### SUMMARY

The scope of protection sought for various example embodiments of the disclosure is set out by the independent claims. The example embodiments and features, if any, described in this specification that do not fall under the scope of the independent claims are to be interpreted as examples useful for understanding various example embodiments of the disclosure.

According to a first aspect, there is provided a device for determining a fill rate of an elevator. The device comprises at least one processor and at least one memory storing instructions that, when executed by the at least one processor, cause the device to at least perform: obtaining a first set of sensor data associated with an empty elevator car from at least one time-of-flight sensor arranged in the elevator car, the first set of sensor data comprising first data points; obtaining floor data points based on the first data points; determining a bounding volume surrounding the floor data points; obtaining a second set of sensor data associated with the elevator car from the least one time-of-flight sensor, the second set of sensor data comprising second data points; and calculating the fill rate of the elevator car at least partly based on the second data points inside the bounding volume. This may enable a simple, accurate and a cost-effect solution for determining the fill rate.

In an implementation form of the first aspect, the bounding volume is a three-dimensional rectangular box. This may enable a determination of a desired volume that will comprise the floor data points.

In an implementation form of the first aspect, the at least one memory stores instructions that, when executed by the at least one processor, cause the device to at least perform: removing data points associated with walls of the elevator car from the first data points to obtain the floor data points. This may enable an efficient solution for determining the floor data points.

In an implementation form of the first aspect, removing the data points associated with the walls of the elevator car from the first data points is executed by a deep learning algorithm for image reconstruction. This may enable an efficient solution for determining the floor data points.

In an implementation form of the first aspect, the fill rate is calculated based on the following equation:

$$Fill rate = \vert Total area of bounding volume - Second data points area inside bounding volume \vert * 100.$$

In an implementation form of the first aspect, the at least one memory stores instructions that, when executed by the at least one processor, cause the device to at least perform: transmitting the calculated fill rate. This may enable an efficient solution for determining the fill rate by a device associated with the elevator car and then transmitting the fill rate for further usage.

According to a second aspect, there is provided an elevator system comprising a device according to the first aspect, and at least one time-of-flight sensor arranged in an elevator car and configured to provide sensor data to the device.

In an implementation form of the second aspect, the elevator system comprises further an elevator controller, wherein the elevator controller is configured to obtain the fill rate, and, based on the fill rate, at least partly to control the elevator car.

In an implementation form of the second aspect, the elevator system further comprises an elevator group controller, wherein the elevator group controller is configured to obtain the fill rate, and, based on the fill rate, to control the elevator car.

In an implementation form of the second aspect, the device is configured to transmit the fill rate to the elevator controller or to the elevator group controller.

According to a third aspect, there is provided a method for calculating a fill rate of an elevator car. The method comprises obtaining a first set of sensor data associated with an empty elevator car from at least one time-of-flight sensor arranged in the elevator car, the first set of sensor data comprising first data points;

obtaining floor data points based on the first data points; determining a bounding volume surrounding the floor data points; obtaining a second set of sensor data associated with the elevator car from the least one time-of-flight sensor, the second set of sensor data comprising second data points; and calculating the fill rate of the elevator car at least partly based on the second data points inside the bounding volume.

In an implementation form of the third aspect, the bounding volume is a three-dimensional rectangular box.

In an implementation form of the third aspect, the method further comprises removing data points associated with walls of the elevator car from the first data points to obtain the floor data points.

In an implementation form of the third aspect, removing the data points associated with the walls of the elevator car from the first data points is executed by a deep learning algorithm.

In an implementation form of the third aspect, the fill rate is calculated based on the following equation:

$$Fill rate = \vert Total area of bounding volume - Second data points area inside bounding volume \vert * 100.$$

In an implementation form of the third aspect, the method further comprises comprising transmitting the calculated fill rate.

According to a fourth aspect, there is provided a computer program comprising instructions which, when the program is executed by at least one processor, cause an apparatus or a device to perform the method of the third aspect.

According to a fifth aspect, there is provided a computer-readable medium comprising a computer program comprising instructions which, when the program is executed by at least one processor, cause an apparatus or a device to perform the method of the third aspect.

According to a sixth aspect, there is provided a device for determining a fill rate of an elevator. The device comprises means for: obtaining a first set of sensor data associated with an empty elevator car from at least one time-of-flight sensor arranged in the elevator car, the first set of sensor data comprising first data points; obtaining floor data points based on the first data points; determining a bounding volume surrounding the floor data points; obtaining a second set of sensor data associated with the elevator car from the least one time-of-flight sensor, the second set of sensor data comprising second data points; and calculating the fill rate of the elevator car at least partly based on the second data points inside the bounding volume. This may enable a simple, accurate and a cost-effect solution for determining the fill rate.

### BRIEF DESCRIPTION OF THE DRAWINGS

The accompanying drawings, which are included to provide a further understanding of the invention and constitute a part of this specification, illustrate examples of the invention and together with the description help to explain the principles of the invention. In the drawings:

FIG. 1 illustrates a flow diagram of a method according to an example embodiment.

FIG. 2 illustrates a block diagram of a device according to an example embodiment.

FIG. 3 illustrates a system according to an example embodiment.

FIG. 4 illustrates an elevator car and a time-of-flight sensor installed in the ceiling of an elevator car according to an example embodiment.

FIG. 5A illustrates an image presentation of time-of-flight sensor data relating to an elevator car according to an example embodiment.

FIG. 5B illustrates an image presentation of time-of-flight sensor data relating to an elevator car, where data points relating to walls have been cropped according to an example embodiment.

FIG. 5C illustrates an image presentation of time-of-flight sensor data relating to an elevator car, where a bounding volume has been defined to surround floor data points according to an example embodiment.

FIG. 5D illustrates an image presentation of preprocessed time-of-flight sensor data from an empty elevator according to an example embodiment.

FIG. presentation of 5E illustrates an image preprocessed time-of-flight sensor data relating to an elevator car with two people inside according to an example embodiment.

### DETAILED DESCRIPTION

Various examples and embodiments discussed below illustrate a solution in which time-of-flight (ToF) sensor data can be used in determining a fill rate of an elevator car. The fill rate may be utilized to control the elevator car, such as to skip a floor. In addition, the sensor data provided by the time-of-flight sensors does not distinguish people's faces, thus providing privacy to passengers.

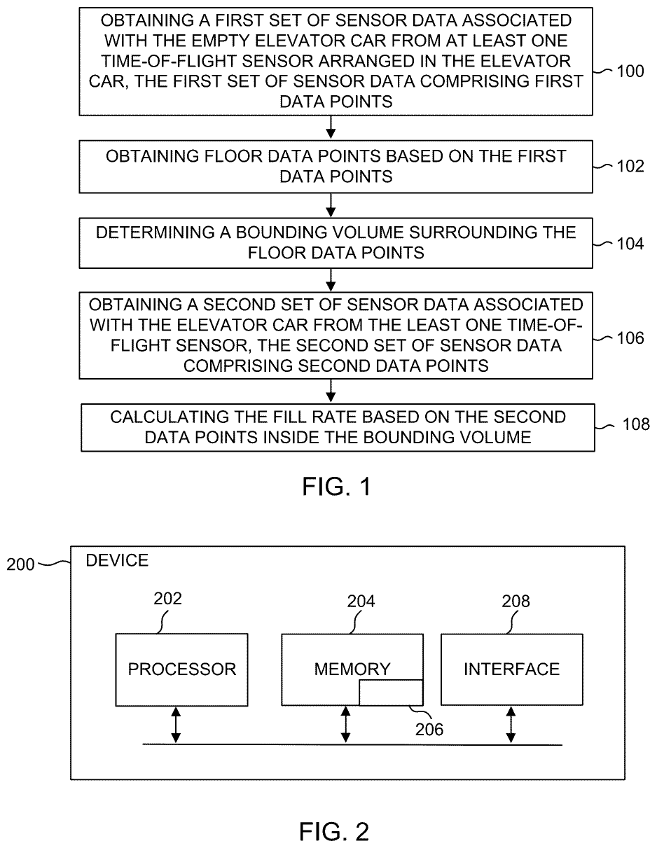

FIG. 1 illustrates a flow diagram according to an example for calculating a fill rate of an elevator car. The method may be implemented, for example, by a device associated with the elevator car, for example, an elevator controller or an elevator group controller.

At 100, a first set of sensor data associated with an empty elevator car may be obtained from at least one time-of-flight (ToF) sensor arranged in the elevator car, the first set of sensor data comprising first data points. In a smaller elevator car, one ToF sensor may be able to cover the inside space of the elevator car. In larger elevator more than only ToF may be used. In an example embodiment, the TOF sensors may be synchronized with each other. For example, if the elevator car is large and one sensor cannot cover the complete floor area, multiple ToF sensors may be installed on the roof and synchronized together to provide better accuracy and coverage for the whole floor area. A ToF sensor is a 3D sensor that uses pulses of invisible infrared laser light to illuminate a subject, and measure the time it takes for the reflected light to reach the image sensor to determine depth information. ToF sensors can illuminate the entire scene and record the depth information in it with a single pulse of laser light.

At 102, floor data points may be obtained based on the first data points. In an example embodiment, the floor data points may be obtained by removing data point associated with walls of the elevator car may be removed from the first data points to obtain the floor data points. In another example embodiment, the floor data points may be manually defined during the installation phase as a provisioning part. For example, a technician may manually make a rectangle based on corners of the floor using a graphical user interface (GUI) based interface.

The first data points may include also data points relating to the walls of the elevator car. As these data points are not needed in the fill rate calculation, they can be removed. The removal of the data points associated with the walls of the elevator car from the first data points may be executed, for example, by a deep learning algorithm.

At 104, a bounding volume surrounding the floor data points may be determined. The bounding volume may have a three-dimensional rectangular shape. In other examples, the shape may be different.

At 106, a second set of sensor data associated with the elevator car may be obtained from the least one time-of-flight sensor, the second set of sensor data comprising second data points. The second set of sensor data may be obtained, for example, when there are passengers in the elevator car.

At 108, the fill rate of the elevator car may be calculated at least partly based on the second data points inside the bounding volume. When there are passengers in the elevator car, the second data points do not fall within the bounding volume. This information can be utilized, when calculating the fill rate. Based on the fill rate unnecessary stops of the elevator car may be avoided. The calculated fill rate may transmitted to one or more entities, for example, an elevator controller or an elevator group controller. In one example, the fill rate may be calculated based on the following equation:

$$Fill rate = \vert Total area of bounding volume - Second data points area inside bounding volume \vert * 100$$

The fill rate can thus be calculated as the difference between the total area of the bounding volume and the total area inside the bounding volume, where the second data points are present. The result may then be normalized to percentage with the final multiplication.

In another example embodiment, the above equation may be modified as per installation configuration. For example, the fill rate may be determined from the volume difference, instead of the area difference, depending on the shape of the elevator and/or the performance metrics of the ToF sensor. In an example embodiment, data points may be normalized before using the volume based difference.

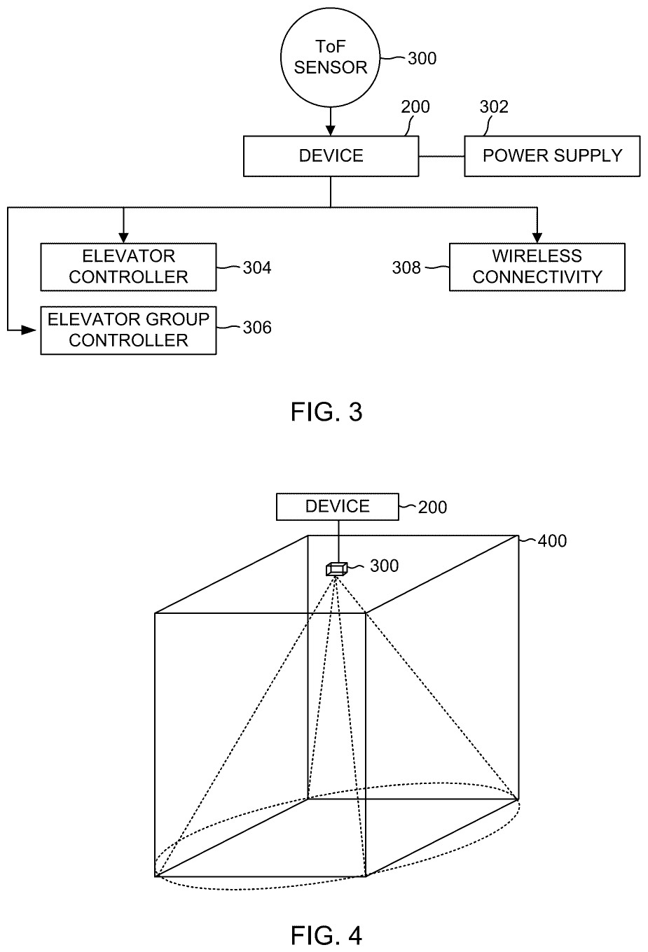

FIG. 2 illustrates a block diagram of an device 200 according to an example embodiment. The device 200 comprises one or more processors 202, and one or more memories 204 that comprise computer program code 206, and/or a communication interface 208 for wired and/or wireless communication. Although the device 200 is depicted to include only one processor 202, the device 200 may include more than one processor. In an example, the memory 204 is capable of storing instructions, such as an operating system and/or various applications.

Furthermore, the processor 202 is capable of executing the stored instructions. In an example embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 202 may be configured to execute hard-coded functionality. In an example embodiment, the processor 202 is embodied as an executor of software instructions, wherein the instructions may specifically configure the processor 202 to perform the algorithms and/or operations described herein when the instructions are executed, for example, the steps discussed relating to FIG. 1.

The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

The at least one memory 204 may store program instructions that, when executed by the at least one processor 202, cause the device 200 to perform the functionality of the various embodiments discussed herein. Further, in an embodiment, at least one of the processor 202 and the memory 204 may constitute means for implementing the discussed functionality. Further, the device 200 may be configured to obtain a first set of sensor data associated with an empty elevator car from at least one time-of-flight sensor arranged in the elevator car, the first set of sensor data comprising first data points; obtain floor data points based on the first data points; determine a bounding volume surrounding the floor data points; obtain a second set of sensor data associated with the elevator car from the least one time-of-flight sensor, the second set of sensor data comprising second data points; and calculate the fill rate of the elevator car at least partly based on the second data points inside the bounding volume.

A computer program for calculating the fill rate of an elevator car may comprise instructions which, when the program is executed by the at least one processor 202, cause the device 200 to perform any of the methods described above. Furthermore, a computer-readable medium may comprise the computer program.

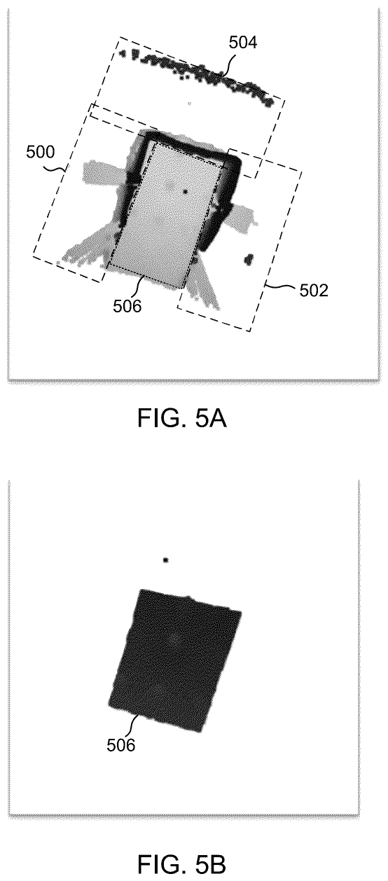

FIG. 3 illustrates how the device 200 may be utilized in an example system. In FIG. 3, a time-of-flight (ToF) sensor 300 provides real-time sensor data to the device 200. The device 200 may be powered by an external power supply 302, as the device 200 may be installed in the elevator car. However, the device 200 may also be installed in any other suitable location. In the example illustrated in FIG. 2, the device 200 may transmit the calculated fill rate, for example, to an elevator controller 304 or to an elevator group controller 306. Alternatively or additionally, the device 200 may transmit the calculated fill rate via a wireless connectivity block 308, such as a 4G/5G modem or a WLAN modem. Through the wireless transmission, the calculated fill rate may be further transmitted to either directly to the elevator controller 304, the elevator group controller 306 or a server located outside an elevator system. The server may be in communication with the elevator controller 304/elevator group controller 306 or a plurality of elevator controllers/elevator group controllers, should the server manage communication with multiple groups of elevators, for example, in a case of a large shopping mall.

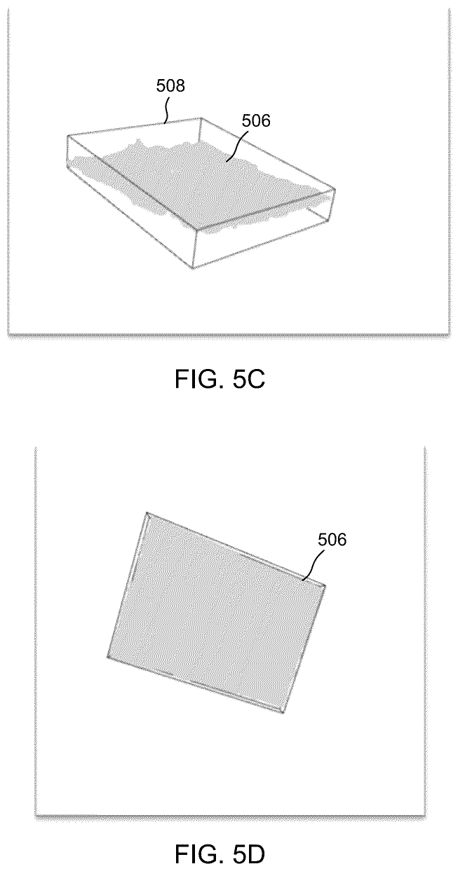

FIG. 4 illustrates an example of an elevator car 400, comprising the ToF sensor 300 installed in a ceiling of the elevator car 400. The ToF sensor 300 is connected to the device 200. The connection may be a wired or wireless connection.

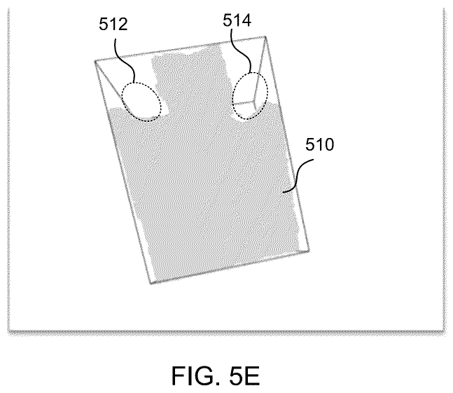

FIG. 5A illustrates an example graphical representation of raw ToF sensor data generated by the ToF sensor 300 and drawn on a GUI of a computer program. Unnecessary data point clusters 500, 502 and 504 may be removed, for example, by an appropriate algorithm. In FIG. 5A, data points in sections 500, 502, 504 can be analyzed to be associated with walls or reflections not being part of floor data points 506. FIG. 5B in turn illustrates an example graphical representation of only the floor data points 506, where the walls have been removed.

FIG. 5C illustrates an example graphical representation, where the bounding volume 508 surrounding the floor data point 506. The height and width of the bounding volume 508 may be the same as the height and width of the area of the floor data point 506. The depth of the bounding volume may be set to be any appropriate value. For example, the depth of the bounding value may be ±X cm from the surface area of the floor data points 506. In the example illustrated in FIG. 5C, the bounding volume 508 may have a three-dimensional rectangular shape. In other examples, also other shapes are possible. FIG. 5D illustrates an example graphical representation of the floor data points 506, when the elevator car 400 is empty.

FIG. 5E illustrates an example graphical representation of floor data points 510 from the elevator car 400, when two passengers are inside the elevator car at locations 512 and 514. Reflections, i.e. data points, of the signal transmitted by the ToF sensor 300 back to the ToF sensor 300 from the passengers inside the elevator car 400 are not within the bounding volume, and therefore, the floor data points 510 lack data points in parts corresponding to the passengers.

In an example embodiment, an elevator system may comprise the device 200, at least one ToF sensor 300 arranged in the elevator car 400 and other system elements discussed above. The elevator system may comprise an elevator controller 304 or an elevator group controller 306 configured to obtain the fill rate calculated by the device 200, and the elevator controller 304 or the elevator group controller 306 may be configured to control the elevator car 400 at least partly based on the fill rate.

The examples discussed above may be implemented in software, hardware, application logic or a combination of software, hardware and application logic. The example devices can store information relating to various methods described herein. This information can be stored in one or more memories, such as a hard disk, a solid state drive (SSD), an optical disk, a magneto-optical disk, an RAM, and the like. One or more databases can store the information used to implement the examples. The databases can be organized using data structures (e.g., records, tables, arrays, fields, graphs, trees, lists, and the like) included in one or more memories or storage devices listed herein. The methods described with respect to the examples can include appropriate data structures for storing data collected and/or generated by the methods of the devices and subsystems of the examples in one or more databases.

The components of the examples may include computer readable medium or memories for holding instructions programmed according to the teachings and for holding data structures, tables, records, and/or other data described herein. In an example, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred examples thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or example may be incorporated in any other disclosed or described or suggested form as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A device for determining a fill rate of an elevator car, comprising:
at least one processor; and
at least one memory storing instructions that, when executed by the at least one processor, cause the device to at least perform:
obtaining a first set of sensor data associated with an empty elevator car from at least one time-of-flight sensor arranged in the elevator car, the first set of sensor data comprising first data points;
obtaining floor data points based on the first data points;
determining a bounding volume surrounding the floor data points;
obtaining a second set of sensor data associated with the elevator car from the least one time-of-flight sensor, the second set of sensor data comprising second data points; and
calculating the fill rate of the elevator car at least partly based on the second data points inside the bounding volume.

2. The device according to claim 1, wherein the bounding volume is a three-dimensional rectangular box.

3. The device according to claim 1, the at least one memory storing instructions that, when executed by the at least one processor, cause the device to at least perform:
removing data points associated with walls of the elevator car from the first data points to obtain the floor data points.

4. The device according to claim 3, wherein removing the data points associated with the walls of the elevator car from the first data points is executed by a deep learning algorithm for image reconstruction.

5. The device according to claim 1, wherein the fill rate is calculated based on the following equation:
$$Fill rate = \vert Total area of bounding volume - Second data points area inside bounding volume \vert * 100$$

6. The device according to claim 1, the at least one memory storing instructions that, when executed by the at least one processor, cause the device to at least perform: transmitting the calculated fill rate.

7. An elevator system comprising:
a device according to claim 1; and
at least one time-of-flight sensor arranged in an elevator car and configured to provide sensor data to the device.

8. The elevator system according to claim 7, further comprising an elevator controller, wherein the elevator controller is configured to obtain the fill rate, and, based on the fill rate, at least partly to control the elevator car.

9. The elevator system according to claim 7, further comprising an elevator group controller, wherein the elevator group controller is configured to obtain the fill rate, and, based on the fill rate, to control the elevator car.

10. The elevator system according to claim 7, wherein the device is configured to transmit the fill rate to the elevator controller or to the elevator group controller.

11. A method for calculating a fill rate of an elevator car, the method comprising:
obtaining a first set of sensor data associated with an empty elevator car from at least one time-of-flight sensor arranged in the elevator car, the first set of sensor data comprising first data points;
obtaining floor data points based on the first data points;
determining a bounding volume surrounding the floor data points;
obtaining a second set of sensor data associated with the elevator car from the least one time-of-flight sensor, the second set of sensor data comprising second data points; and
calculating the fill rate of the elevator car at least partly based on the second data points inside the bounding volume.

12. The method according to claim 11, wherein the bounding volume is a three-dimensional rectangular box.

13. The method according to claim 11, further comprising:
removing data points associated with walls of the elevator car from the first data points to obtain the floor data points.

14. The method according to claim 13, wherein removing the data points associated with the walls of the elevator car from the first data points is executed by a deep learning algorithm.

15. The method according to claim 11, wherein the fill rate is calculated based on the following equation:
$$Fill rate = \vert Total area of bounding volume - Second data points area inside bounding volume \vert * 100$$

16. The method according to claim 11, further comprising transmitting the calculated fill rate.

17. A non-transitory computer-readable medium storing a computer program comprising instructions which, when the program is executed by at least one processor, cause a device to perform the method of claim 11.

18. A non-transitory computer-readable medium comprising a computer program comprising instructions which, when the program is executed by at least one processor, cause a device to perform the method of claim 12.

19. The device according to claim 2, the at least one memory storing instructions that, when executed by the at least one processor, cause the device to at least perform:
removing data points associated with walls of the elevator car from the first data points to obtain the floor data points.

20. The device according to claim 2, wherein the fill rate is calculated based on the following equation:
$$Fill rate = \vert Total area of bounding volume - Second data points area inside bounding volume \vert * 100$$
